(19) United States
(12) Patent Application Publication
(10) Pub. No.: US 2013/0187560 A1
(43) Pub. Date: Jul. 25, 2013

(54) LIGHT SOURCE APPARATUS FOR DETECTING PATHOLOGICAL CHANGE IN AN ORAL CAVITY

(71) Applicants: HSIANG-CHEN WANG, CHIAYI COUNTY (TW); YUNG-TSAN CHEN, CHIAYI COUNTY (TW)

(72) Inventors: HSIANG-CHEN WANG, CHIAYI COUNTY (TW); YUNG-TSAN CHEN, CHIAYI COUNTY (TW)

(73) Assignee: NATIONAL CHUNG CHENG UNIVERSITY, CHIAYI COUNTY (TW)

(21) Appl. No.: 13/355,592

(22) Filed: Jan. 23, 2012

(51) Int. Cl. H05B 37/02

(52) U.S. Cl. 315/201; 315/297

(57) ABSTRACT

A light source apparatus for detecting pathological change in an oral cavity has an LED unit and a control unit. The LED unit has multiple LEDs, and each LED has one of three primary colors. The control unit is electrically connected to the LED unit to adjust an operating voltage of each LED so that a spectral range of a light source mixed by the three primary colors of the LEDs is located in a range of x=0.349±0.0046, y=0.57495±0.00355 on the chromaticity coordinates. The light source apparatus can generate high chromatic aberration and high contrast between a normal area and an area with pathological change when emitting light to a diagnosed area in the oral cavity.

### BACKGROUND OF THE INVENTION

1. Field of the Invention

The present invention relates to an apparatus for detecting pathological change in an oral cavity and more particularly to an apparatus emitting light with a specific spectrum to an oral cavity to generate high chromatic aberration and contrast between an area with pathological change and a normal area in the oral cavity.

2. Description of the Related Art

Incandescent lamps, xenon lamps and halogen lamps are the light sources normally used in medical application. In contrast to the foregoing lamps, medical light sources using light-emitting diode (LED) are advantageous in low power consumption, high lighting efficiency, long life span, environmental protection, compact size, adjustable light intensity and abundant light gamut.

Using ultraviolet LED and blue LED to excite biological organization in generation of fluorescent image has already been a known technique. The generated fluorescent image creates chromatic aberration and contrast between a normal area and an area with pathological change to enhance recognition of an area having pathological change with human vision. Alternatively, a polarization filter is used in collaboration with the polarization fraction image generated by white LED to enhance recognition of an area having pathological change by human eyes.

Recognition of regular pink and flesh-colored biological organization having pathological change can be described by using enterovirus as an example. Pathological changes arising from enterovirus, such as acute pharyngitis, herpangina and hand-foot-mouth disease are the most contagious diseases in recent years threatening young children under five in particular. If treated in the early stage of enteroviral infection, patients with critical enteroviral infection can be significantly reduced. One way for pediatricians to recognize enterovirus is through the diagnosis of throat, hands and mouth. As patients are normally children, doctors normally have very short time in detecting if enteroviral lesions are found in the oropharyngeal mucosas of the patients when diagnosing. A special light source that is implemented to increase the chromatic aberration between an area with pathological change and the surrounding organization can greatly enhance doctors' recognition ability to distinguish an infected area and a normal area in the oral cavity.

### SUMMARY OF THE INVENTION

An objective of the present invention is to provide a light source apparatus for detecting pathological change of an oral cavity capable of generating apparent contrast and chromatic aberration between an area with pathological change and a normal area in the oral cavity.

To achieve the foregoing objective, the light source apparatus for detecting pathological change of an oral cavity has an LED unit and a control unit.

The LED unit is composed of multiple LEDs, and each LED has one of three primary colors.

The control unit is electrically connected to the LED unit to adjust an operating voltage of each LED so that a spectral range of a beam of detection light mixed by the three primary colors of the LEDs is located in a range of x=0.349±0.0046, y=0.57495±0.00355 on the chromaticity coordinates. As the control unit controls a spectral range of the detection light outputted by the LED unit to be located in a range of x=0.349±0.0046, y=0.57495±0.00355 on the chromaticity coordinates, when the light source apparatus is applied to detect regular reddish biological organization, such as oral cavity of human body, high contrast and high chromatic aberration can be generated between a normal area and an area with pathological change to facilitate identifying the infected area and achieve the effect of early treatment. Other objectives, advantages and novel features of the invention will become more apparent from the following detailed description when taken in conjunction with the accompanying drawings.

### BRIEF DESCRIPTION OF THE DRAWINGS

This application contains at least one drawing executed in color. A Petition under 37 C.F.R. section 1.84 requesting acceptance of the color drawings is filed separately on even date herewith. Copies of this patent or patent application publication with color drawing(s) will be provided by the Office upon request and payment of the necessary fee.

FIG. 1 is a functional block diagram of a light source apparatus for detecting pathological change in oral cavity in accordance with the present invention;

FIGS. 2A to 2L are spectral distribution diagrams of light sources having different color temperatures in accordance with the present invention;

FIG. 3 is a chromaticity diagram of all the light sources in FIGS. 2A to 2L distributed in the CIE chromaticity coordinates;

FIGS. 4A to 4F are spectral distribution diagrams of light sources having different color saturations in accordance with the present invention;

FIG. 5 is a chromaticity diagram of all the light sources in FIGS. 4A to 4F distributed on the CIE chromaticity coordinates;

FIGS. 6A to 6F are spectral distribution diagrams of different light sources in accordance with the present invention;

FIGS. 7A to 7H are color images of oral cavity images generated under different test light sources in accordance with the present invention; and

FIG. 8 is a chromaticity diagram of the optimal light source located in the CIE chromaticity coordinates in accordance with the present invention.

### DETAILED DESCRIPTION OF THE INVENTION

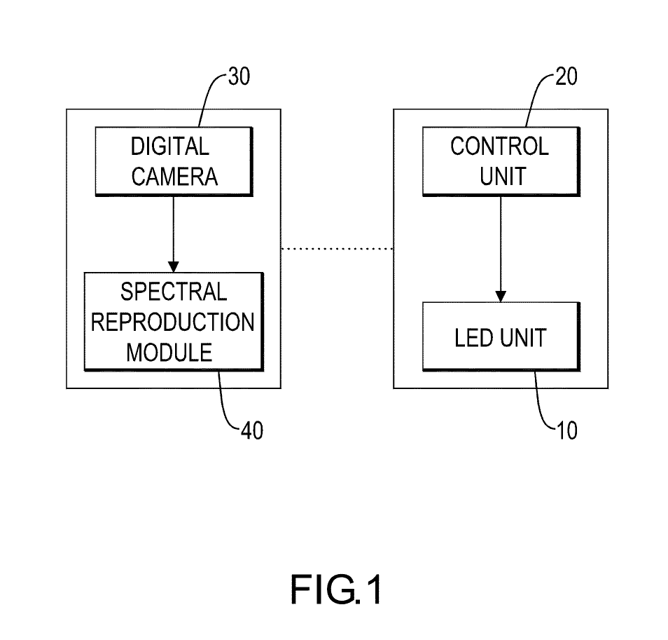

With reference to FIG. 1, a light source apparatus in accordance with the present invention has an LED unit 10 and a control unit 20.

The LED unit 10 is composed of multiple LEDs. Each LED has one of the three primary colors (Red, Green and Blue). When the LEDs of the LED unit 10 emit, a beam of detection light is formed by mixing the three primary colors of the LEDs.

The control unit 20 is electrically connected to the LED unit 10 to respectively adjust operating voltages of the LEDs so that the beam of detection light mixed by the three primary colors of the LEDs is located within an expected spectral range. The control unit 20 may be an AC to DC conversion control circuit or at least one rechargeable battery incorporated with a DC to DC conversion control circuit.

To identify the beam of detection light located within the expected spectral range, the light source apparatus further has a digital camera 30 and a spectral reproduction module 40.

The digital camera 30 serves to take pictures and stores images of the taken pictures. In the present embodiment, the digital camera 30 serves to take images of diagnosed areas.

The spectral reproduction module 40 is connected to the digital camera 30. Images taken by the digital camera 30 are digital and thus different from the images viewed by human eyes. After receiving an image of the digital camera 30, the spectral reproduction module 40 performs a spectral analysis processing on the image to convert the image into an image approximating human vision, and then outputs the analyzed result to the control unit 20 so that the control unit 20 can adjust an operating voltage of each LED for the LED unit 10 to mix the emitted light to form an expected light source.

When performing the spectral analysis processing, the spectral reproduction module 40 executes a color correction means and a color adaptation transformation means to complete image conversion through an existing multi-spectral image reproduction means. After spectral information of each pixel in the converted image is obtained, the spectral information is divided by the spectrum of the light source at the time when the digital camera takes the picture of the image and is further multiplied by spectral information of a test light source. The test light source may be different light sources to simulate the color rendering of the converted image under different spectra.

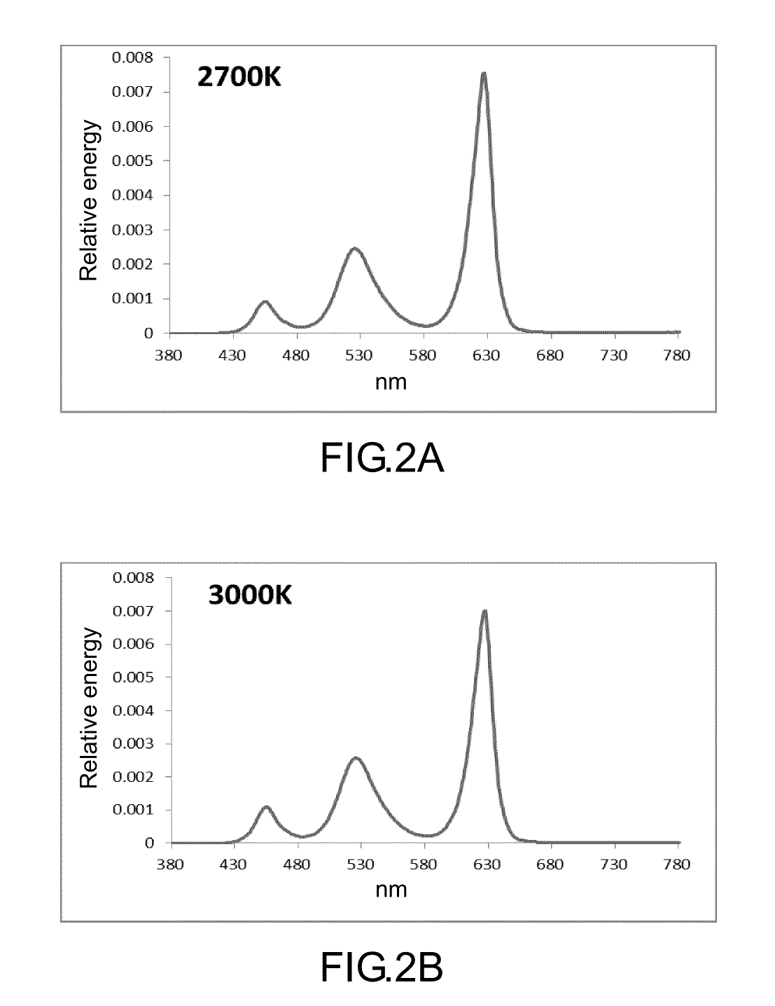

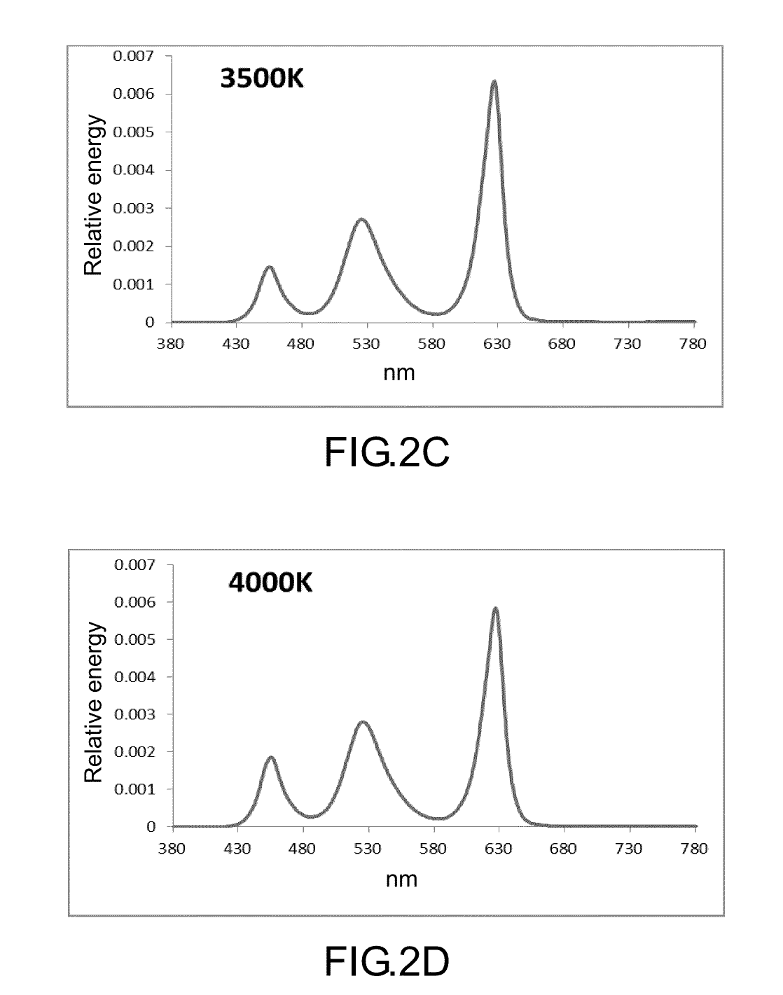

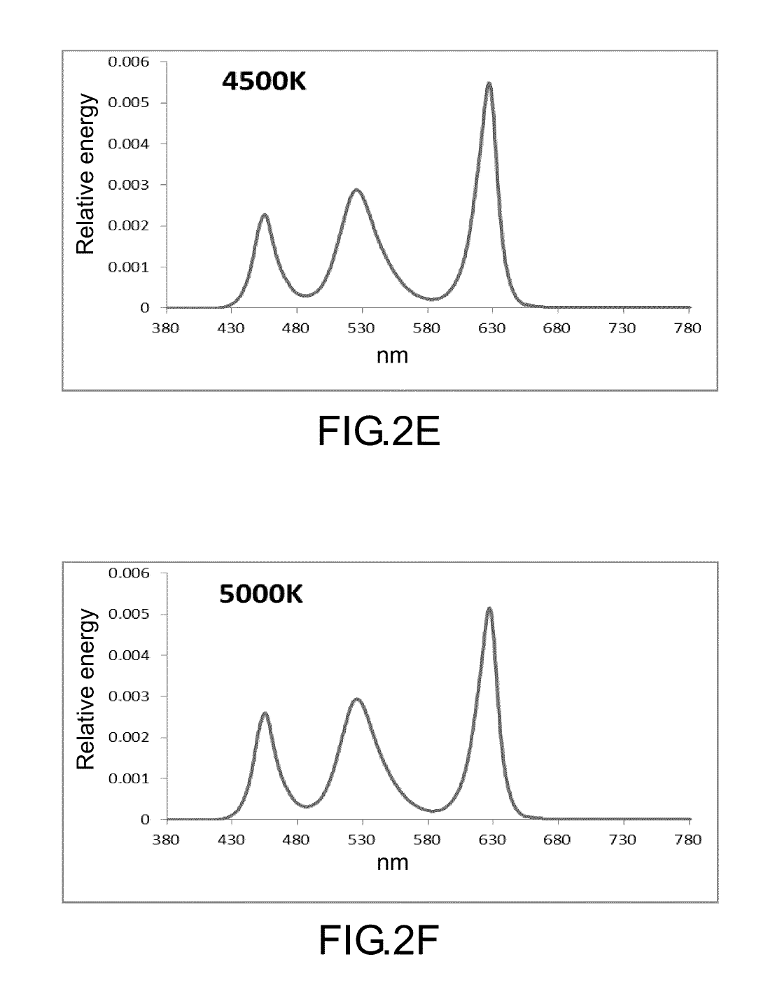

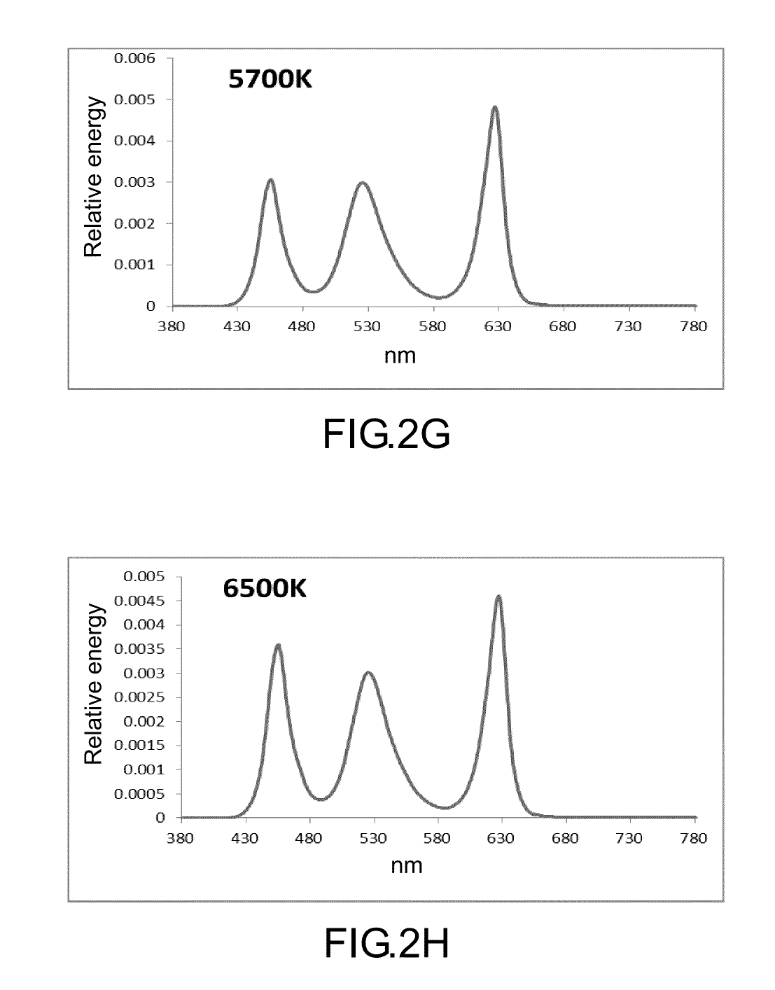

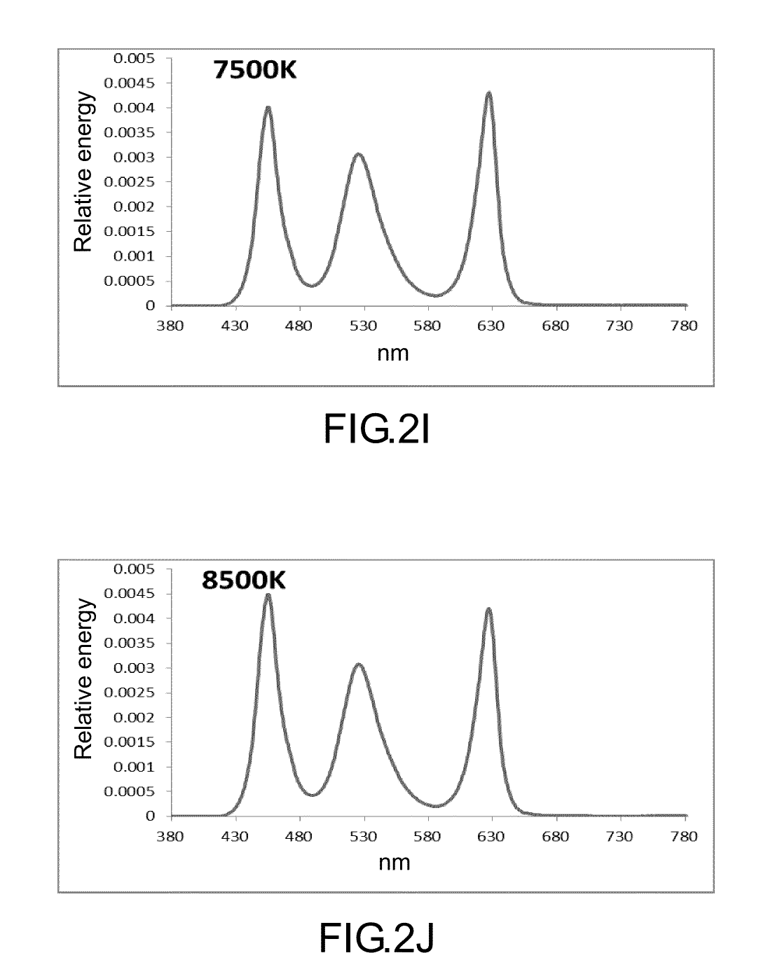

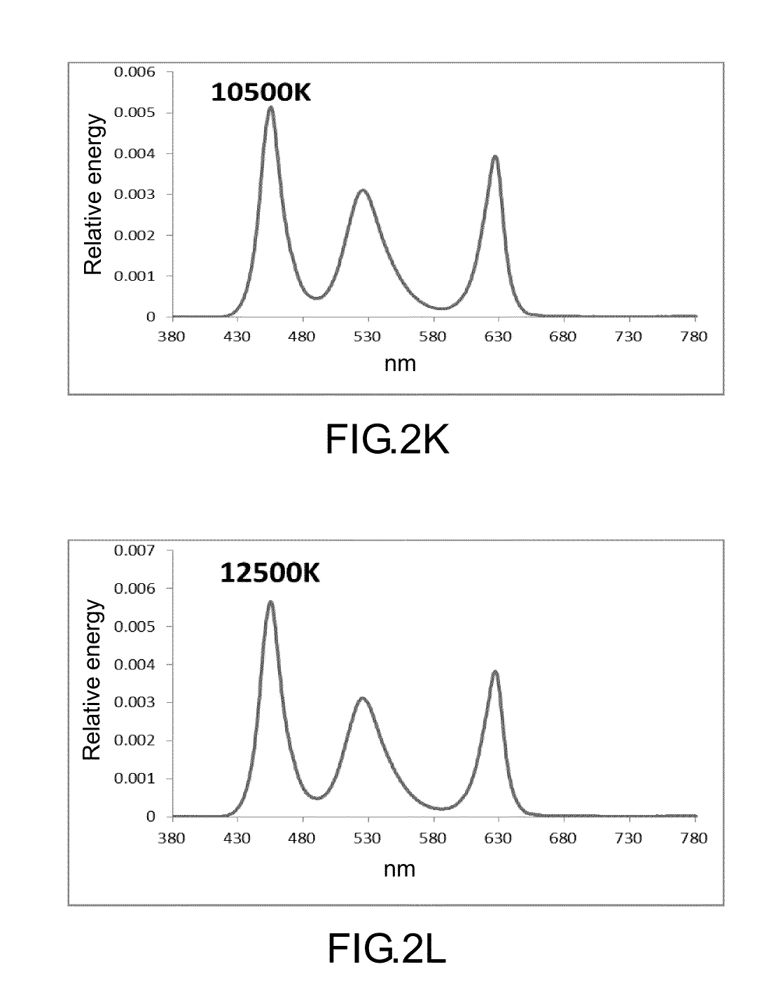

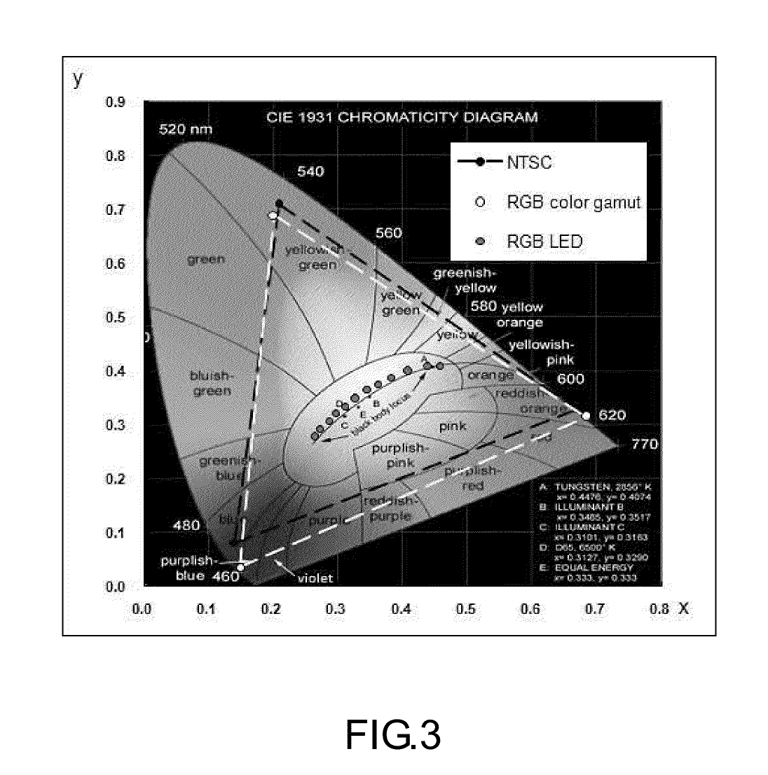

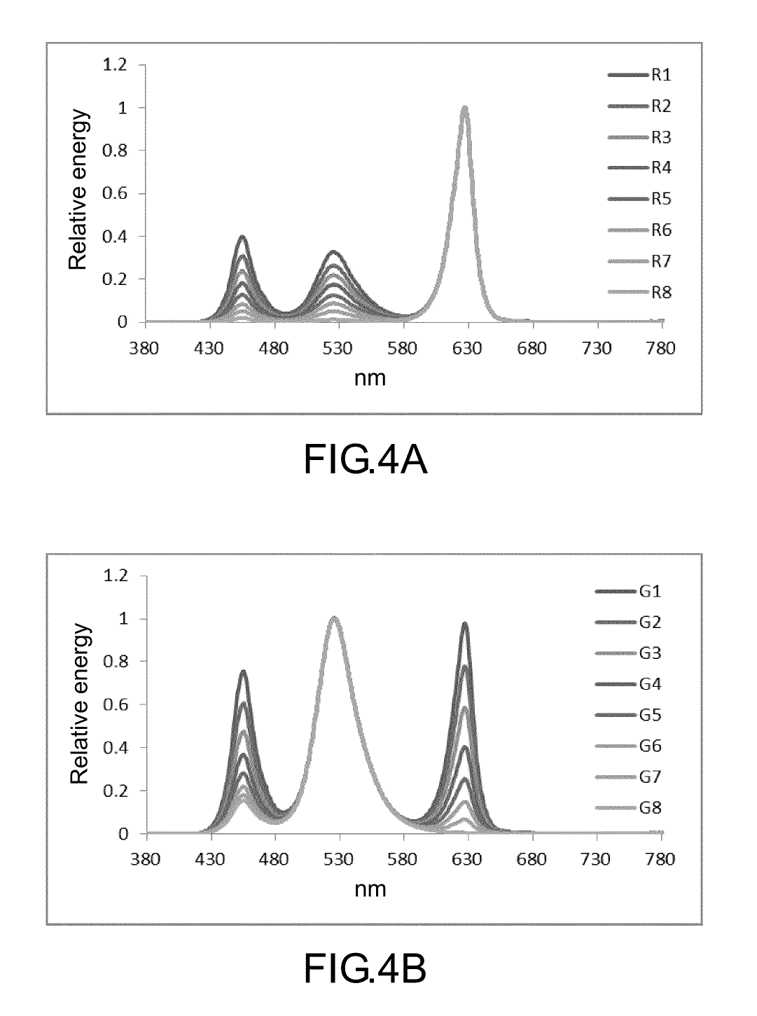

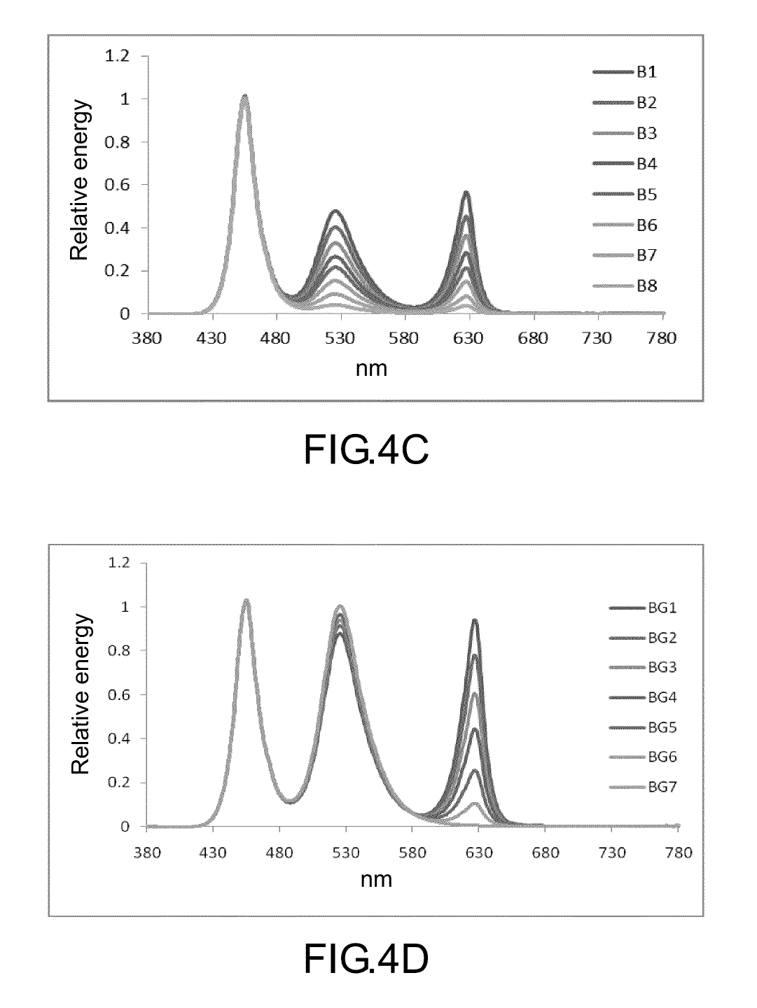

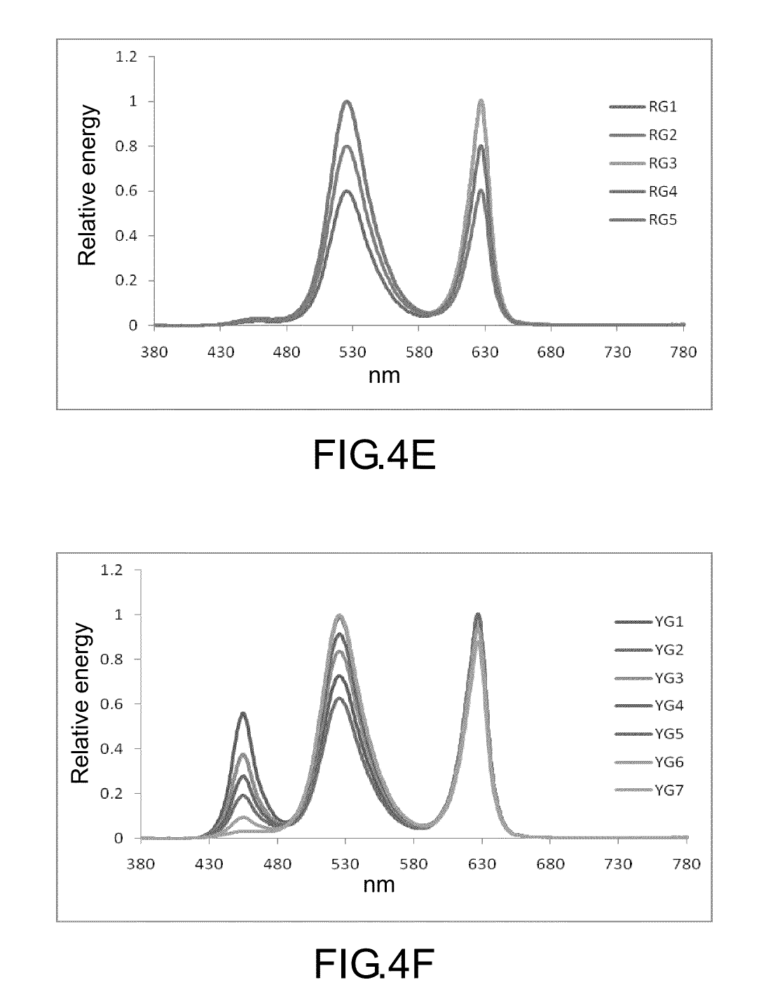

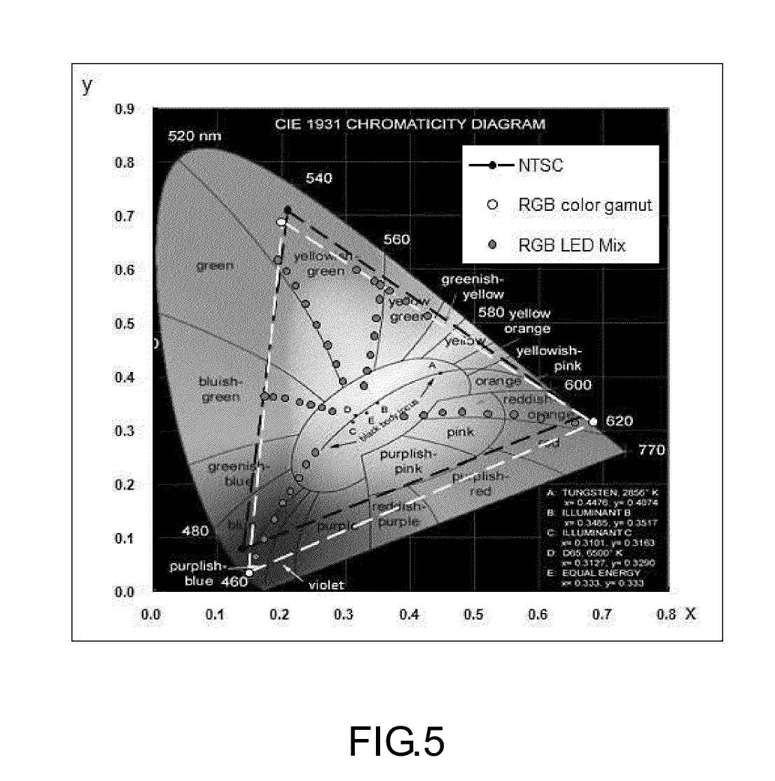

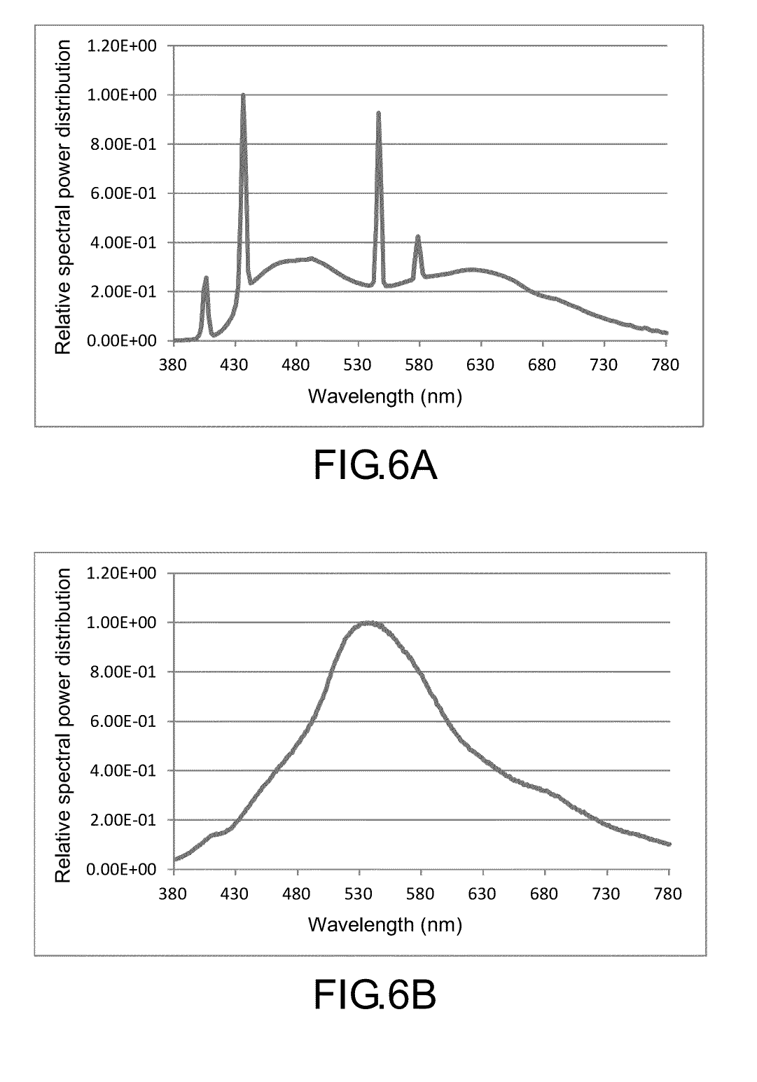

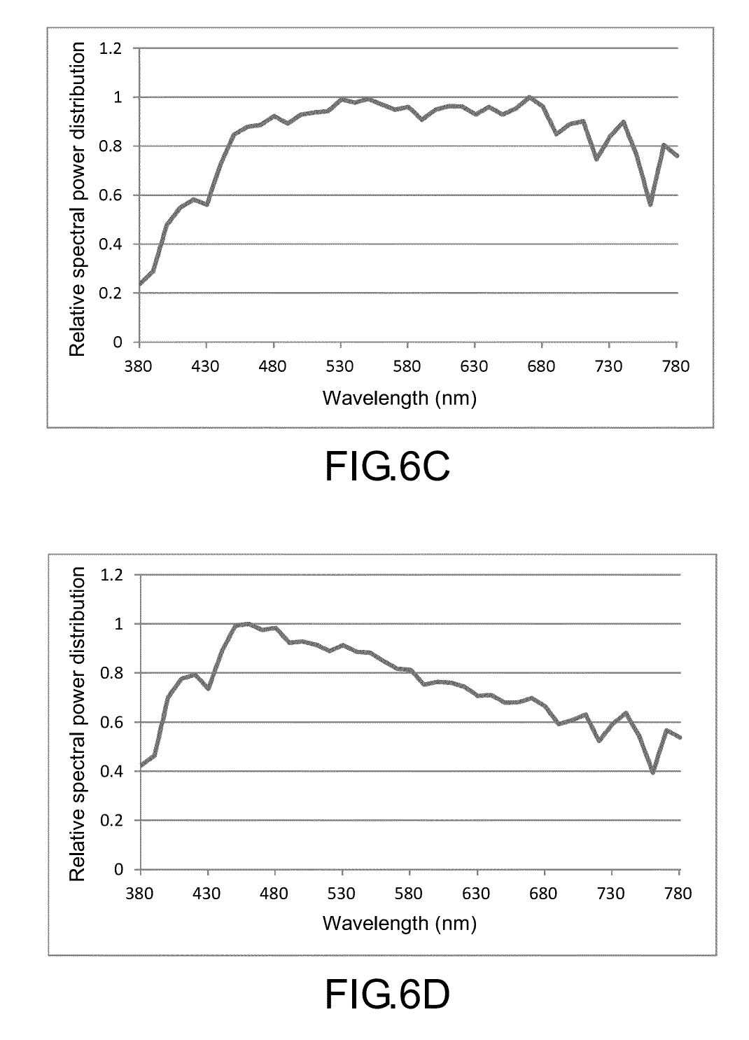

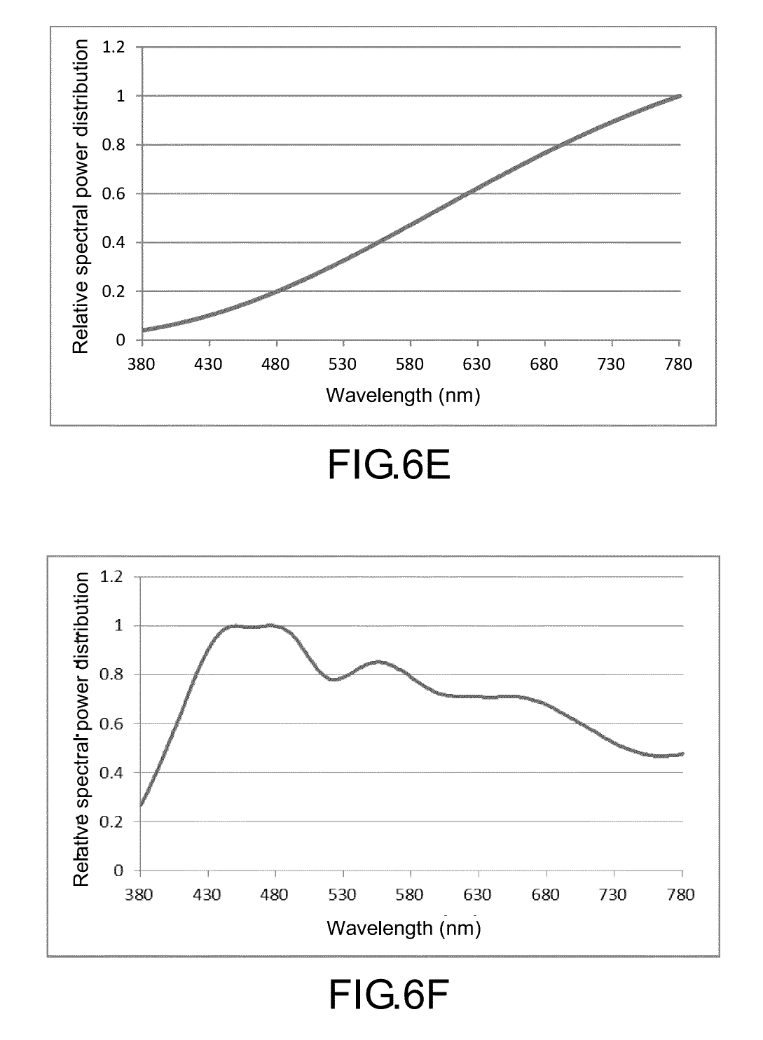

The light source apparatus employs multiple test light sources to irradiate a diagnosed area. With reference to FIGS. 2A to 2L and FIG. 3, the spectral distribution diagrams of multiple test light sources having color temperatures in a range of 2700K˜12500K are shown. The test light sources having different color temperatures are represented by the red dots marked on the CIE chromaticity coordinates in FIG. 3. With reference to FIGS. 4A to 4F and FIG. 5, the spectral distribution diagrams regarding degrees of color saturation of various test light sources are shown. The R, G, B, BG, RG and YG respectively stand for red, green, blue, bluish green, yellow and yellowish green test light sources. The numbers 1-8 stand for degrees of color saturation. The test light sources in FIGS. 4A to 4F are represented by the red dots marked on FIG. 5. With reference to FIGS. 6A to 6F, the spectral distribution diagrams of frequently used light sources, including fluorescent lamp, incandescent lamp, D50 light source, D65 light source, CIE-A light source and CIE-C light source, are sequentially shown.

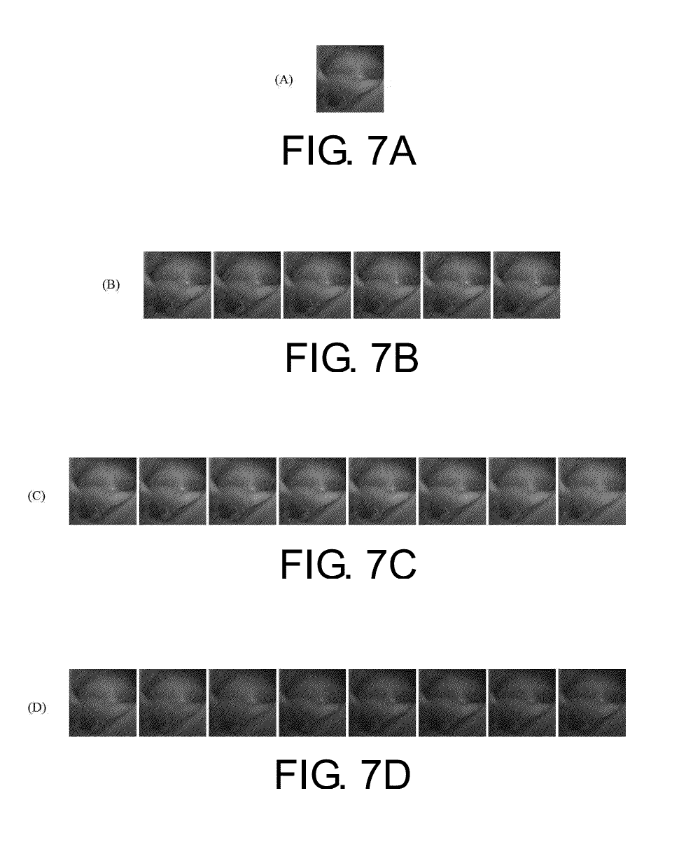

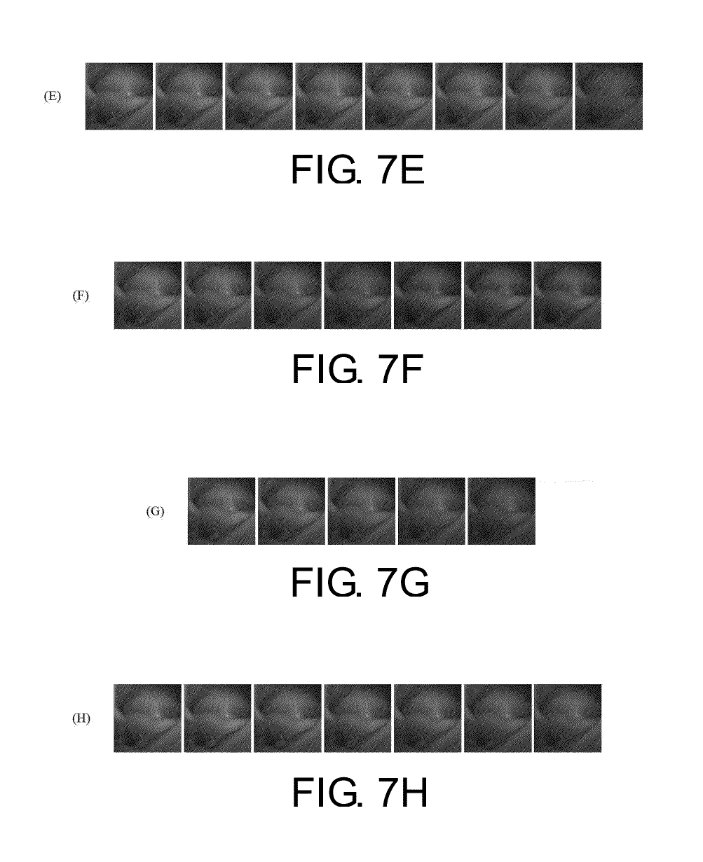

With reference to FIGS. 7A to 7H, color images of multiple oral cavity images are converted by the spectral reproduction module 40 and taken under different test light sources. FIG. 7A is an original image. FIG. 7B contains a row of images from left to right corresponding to the test light sources in FIGS. 6A to 6F. FIGS. 7C to 7H contain six rows of images respectively taken under red light, green light, blue light, bluish green light, yellow light and yellowish green light and different degrees of color saturation.

In the foregoing images, the chromatic aberration between an area with pathological change and a normal area in the oral cavity is calculated to obtain a test light source generating largest aberration between the area with pathological change and the normal area. The distribution range of the test light source generating largest aberration is marked on the CIE chromaticity coordinates. With reference to Table 1, a comparison table having the chromatic aberration of the area with pathological change and the normal area in the oral cavity generated when the foregoing test light sources are applied to take pictures of the oral cavity is shown.

TABLE 1
Comparison table of chromatic aberration of the area
with pathological change and the normal area in the oral
cavity generated under various test light sources

| | Average | Max. | Min. | |
|---|---|---|---|---|
| Light | chromatic | chromatic | chromatic | Standard |
| source | aberration | aberration | aberration | deviation |
| Color temp. | 23.5457 | 26.87688 | 18.34546 | 1.602762 |
| 2700 K | | | | |
| Color temp. | 23.92732 | 27.62126 | 18.37334 | 1.696851 |
| 3000 K | | | | |
| Color temp. | 24.30366 | 28.20222 | 18.73776 | 1.609095 |
| 3500 K | | | | |
| Color temp. | 24.41689 | 28.64165 | 18.72279 | 1.800393 |
| 4000 K | | | | |
| Color temp. | 24.61112 | 28.26436 | 18.48075 | 1.731464 |
| 4500 K | | | | |
| Color temp. | 24.36904 | 29.00062 | 18.56148 | 1.840538 |
| 5000 K | | | | |
| Color temp. | 24.32844 | 28.48488 | 19.06859 | 1.632616 |
| 5700 K | | | | |
| Color temp. | 24.1066 | 28.49385 | 18.44165 | 1.752614 |
| 6500 K | | | | |
| Color temp. | 23.99566 | 28.71898 | 18.44657 | 1.809716 |
| 7500 K | | | | |
| Color temp. | 23.78051 | 28.46814 | 17.78419 | 1.898506 |
| 8500 K | | | | |
| Color temp. | 23.60822 | 27.99327 | 17.94308 | 1.742724 |
| 9500 K | | | | |
| Color temp. | 23.62192 | 28.61494 | 18.12857 | 1.868175 |
| 10500 K | | | | |
| Color temp. | 23.21096 | 27.98087 | 17.48743 | 1.784907 |
| 11500 K | | | | |
| Color temp. | 23.22525 | 28.35029 | 17.27379 | 1.932389 |
| 12500 K | | | | |
| R1 | 22.6649 | 26.25909 | 17.51537 | 1.545351 |
| R2 | 22.22856 | 25.49723 | 17.26077 | 1.547311 |
| R3 | 21.89716 | 25.20648 | 17.13738 | 1.477634 |
| R4 | 21.51352 | 24.80541 | 16.63941 | 1.466595 |
| R5 | 21.0168 | 24.62393 | 16.4644 | 1.403049 |
| R6 | 19.8337 | 23.09121 | 15.94507 | 1.267895 |
| R7 | 18.72895 | 22.33479 | 14.91441 | 1.256539 |
| R8 | 17.6517 | 21.16675 | 13.54445 | 1.448061 |
| G1 | 25.51823 | 30.73354 | 18.90155 | 2.026615 |
| G2 | 25.54982 | 31.59598 | 19.36947 | 2.089267 |
| G3 | 25.9219 | 31.0482 | 19.39641 | 2.066507 |
| G4 | 25.21241 | 30.55703 | 18.8391 | 1.996984 |
| G5 | 18.74345 | 22.52362 | 14.32223 | 1.593653 |
| G6 | 20.60917 | 24.77518 | 15.58319 | 1.67359 |
| G7 | 21.73876 | 25.94507 | 16.58613 | 1.762746 |
| G8 | 23.0063 | 27.70869 | 17.73149 | 1.849579 |
| B1 | 22.59166 | 27.70394 | 16.86464 | 1.860923 |
| B2 | 22.01309 | 27.42268 | 16.827 | 1.791675 |
| B3 | 21.28388 | 26.6078 | 16.31369 | 1.760588 |
| B4 | 20.52671 | 25.4775 | 15.74577 | 1.709373 |
| B5 | 19.80944 | 24.73957 | 14.89302 | 1.725953 |
| B6 | 18.89131 | 23.14041 | 14.42004 | 1.632278 |
| B7 | 17.31214 | 22.25876 | 13.59715 | 1.532267 |
| B8 | 8.364515 | 12.72072 | 5.743355 | 1.174341 |
| BG1 | 24.38013 | 29.15698 | 18.53758 | 1.912935 |
| BG2 | 24.43752 | 29.87029 | 18.33213 | 1.918087 |
| BG3 | 24.03364 | 29.18567 | 17.78599 | 1.995339 |
| BG4 | 23.20238 | 28.88762 | 17.05962 | 2.001869 |
| BG5 | 18.75566 | 22.87735 | 14.30802 | 1.67086 |
| BG6 | 19.44674 | 23.41006 | 14.9392 | 1.557484 |
| BG7 | 19.81227 | 23.9189 | 15.49552 | 1.556003 |
| YG1 | 25.25296 | 29.85015 | 79.29825 | 1.904169 |
| YG2 | 25.17628 | 29.7028 | 19.00754 | 1.763725 |
| YG3 | 26.17429 | 30.9564 | 20.09689 | 1.889618 |
| YG4 | 26.74462 | 31.47511 | 20.23138 | 1.986312 |
| YG5 | 27.3055 | 32.82513 | 20.24118 | 2.072545 |
| YG6 | 27.79801 | 32.67237 | 20.62863 | 2.054279 |
| YG7 | 28.19017 | 33.66994 | 21.29952 | 2.089938 |
| RG1 | 26.34757 | 31.20284 | 20.0931 | 1.927655 |
| RG2 | 27.42346 | 32.67657 | 20.73112 | 1.967983 |
| RG3 | 27.99561 | 32.8202 | 20.91532 | 2.084711 |
| RG4 | 28.18977 | 33.25765 | 20.64853 | 2.161833 |
| RG5 | 27.98483 | 33.44873 | 20.77094 | 2.233748 |
| Fluorescent | 21.49301 | 25.64734 | 16.27421 | 1.64991 |
| lamp | | | | |
| Incandescent | 22.03884 | 26.24246 | 16.44878 | 1.667385 |
| lamp | | | | |
| CIE-A | 21.9235 | 25.18886 | 16.77697 | 1.522546 |
| CIE-C | 21.40319 | 25.05975 | 16.16743 | 1.620613 |
| D50 | 21.90738 | 25.89475 | 16.43134 | 1.680621 |
| D65 | 21.59938 | 25.72684 | 16.23666 | 1.689882 |

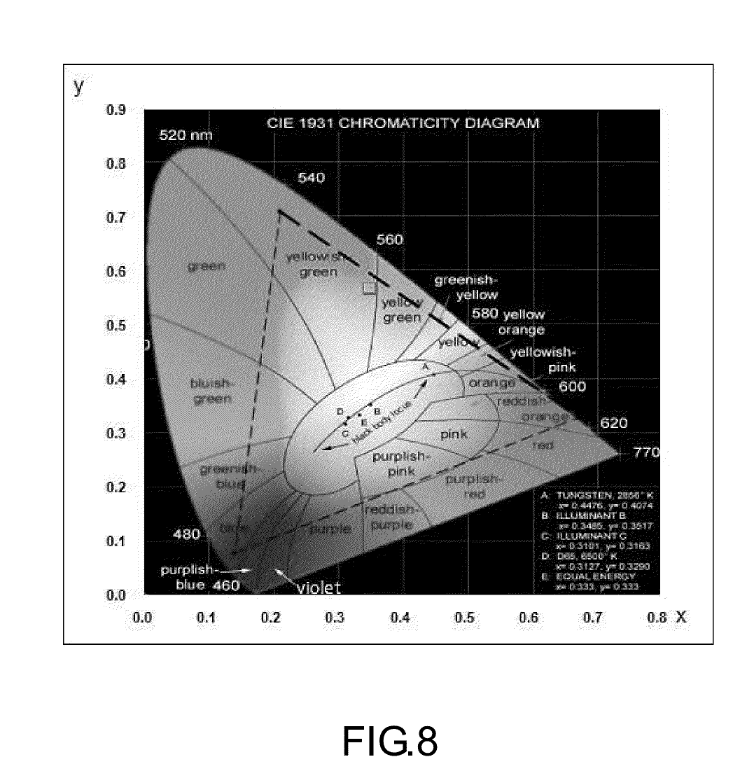

From Table 1 the largest and second largest average aberrations between the area with pathological change and the normal area are respectively generated by two test light sources “YG7” and “RG4”. The distribution range of the test light sources “YG7” and “RG4” is x=0.349±0.0046, y=0.57495±0.00355 (a red frame indicated by a red arrow on FIG. 8). In other words, as long as a light source in the distribution range is selected to generate detection light, an optimal light source capable of recognizing an area with pathological change and a normal area in the oral cavity can be identified.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light source apparatus for detecting pathological change of an oral cavity, comprising:
a light-emitting diode (LED) unit composed of multiple LEDs, wherein each LED has one of three primary colors; and
a control unit electrically connected to the LED unit to adjust an operating voltage of each LED so that a spectral range of a beam of detection light mixed by the three primary colors of the LEDs is located in a range of x=0.349±0.0046, y=0.57495±0.00355 on the chromaticity coordinates.

2. The light source apparatus as claimed in claim 1, wherein the control unit is an AC to DC conversion control circuit.

3. The light source apparatus as claimed in claim 1, wherein the control unit is at least one rechargeable battery incorporated with a DC to DC conversion control circuit.
